(19) United States
(12) Patent Application Publication
(10) Pub. No.: US 2017/0175894 A1
(43) Pub. Date: Jun. 22, 2017

(54) SEAL ASSEMBLY

(71) Applicant: Lars Thomas Johansson, Yven (NO)

(72) Inventor: Lars Thomas Johansson, Yven (NO)

(21) Appl. No.: 15/383,470

(22) Filed: Dec. 19, 2016

(30) Foreign Application Priority Data
Dec. 20, 2015 (NO) 20151757

(51) Int. Cl. F16J 15/00; F16J 15/3232; F16C 33/78; F16J 15/3284

(52) U.S. Cl. CPC F16J 15/002; F16J 15/3284; F16J 15/3232; F16C 33/7816

(57) ABSTRACT

The invention is a seal comprising a first inner seal member (308) configured to be in sealing contact (320c, 320d) with an circular rotating body inside said inner first seal member and further configured to rotate relative said circular rotating body wherein said seal comprises a second outer seal member (301) configured to be fixed relative an outer body, wherein an inner circular circumferential of said second seal member has a common seal interface (320a, 320b) with said first inner seal member, and are individually rotatable.

### TECHNICAL FIELD

The present invention relates to the field of seals and can be used where there is a need for a seal between a fixed and a rotating body. The seal device is especially suitable for high rotational speeds and/or where it is desirable with low friction.

### BACKGROUND

The present invention relates to any seals, but especially seals applied in rolling and/or ball bearings and between a fixed and a rotating component. In a seal between a fixed and a rotating component it is difficult to combine high normal load which the seal exerts on the movable body with low friction. It is also difficult to combine low friction with high rotational speed and good sealing properties.

Known seals have a relatively short lifetime due to friction and wear and they consume a lot of energy. For instance, lip seals can account for approximately 75% of the total bearing power loss. It is desirable with extended service life and a more energy efficient solution. The function of a seal can both be to separate two media, protect against ingress of pollutants, retain the lubricant or retain the pressure between a fixed and a movable body.

Friction force/torque can be recognized as the limiting factors in the case of the seals operating on the high-speed shafts. Elastomer lip seals sealing the engine crankshafts generate relatively small torque, but their power consumption is large due to high angular speed. Combined with small heat conduction, the friction loss increases temperature at the sealing interface. This leads to seal ageing, wear and a reduced service life. It is possible to reduce frictional loss, either through decreasing normal load which the seal exerts on the movable body or by means of decreasing the friction coefficient. Patent U.S.20080309013 A1 and patent U.S. Pat. No. 4,266,786 describes a mechanical seal that aims to extend service life, reduced wear and less heat is generated through the use of a freely rotatable central seal ring.

Patent WO2013076196 aims to reduce friction and wear at elevated temperatures through a temperature sensitive actuator that decreases normal load witch the seal exerts on the rotating body.

### SHORT SUMMARY OF THE INVENTION

This invention reduces friction, wear and tear through a seal comprising inner and outer circular seal members wherein the seal members are rotatable with respect to each other. This yields a reduced relative motion at the seal interface. This leads to an extended service life, a reduction in friction and enables higher rotational speeds.

An object of the present invention is to deal with the previously mentioned disadvantages.

It is a particular object of the present invention to provide a seal that is easy to install, that prevents the lubricant from leaking, even under the effect of an increased pressure inside the sealed component, and that can prevent the influx of moisture, dust or other bodies.

It is a particular object of the present invention to provide a seal with improved friction, wear and tear properties and an extended service life.

The invention is a seal comprising a first inner seal member (308) configured to be in sealing contact (320c, 320d) with an circular rotating body inside said inner first seal member and further configured to rotate relative said circular rotating body wherein said seal comprises a second outer seal member (301) configured to be fixed relative an outer body, wherein an inner circular circumferential of said second seal member has a common seal interface (320a, 320b) with said first inner seal member, and are individually rotatable.

### FIGURE CAPTIONS

An illustrative and non-limiting embodiment of the present invention will be described below in detail with reference to the appended drawings, in which:

FIG. 3 illustrates an embodiment of the invention according to a partial cross section of a radial seal comprising inner and outer seal member.

FIG. 3a illustrates the common seal interface between inner and outer seal member.

### EMBODIMENTS OF THE INVENTION

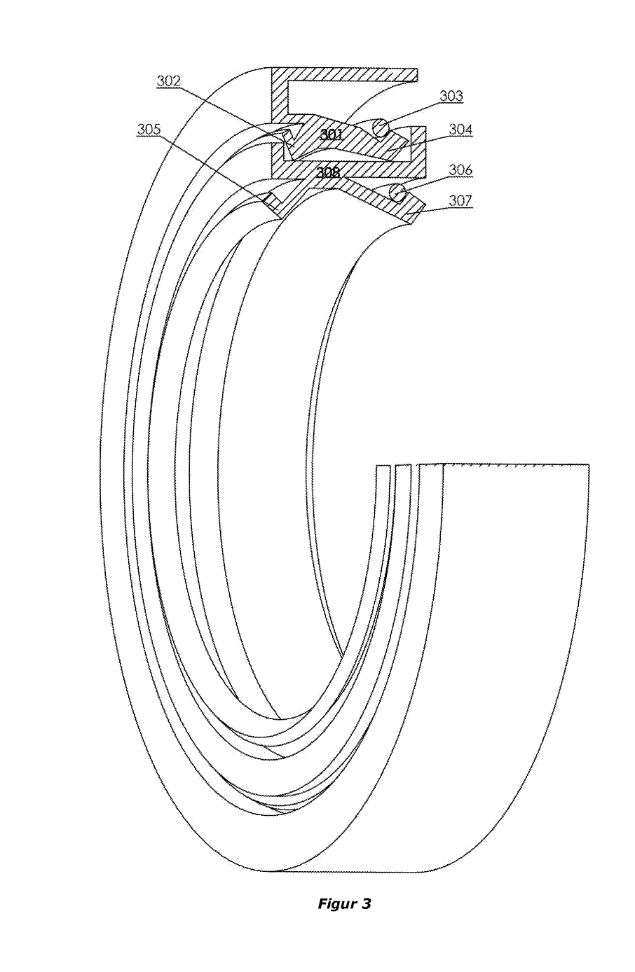

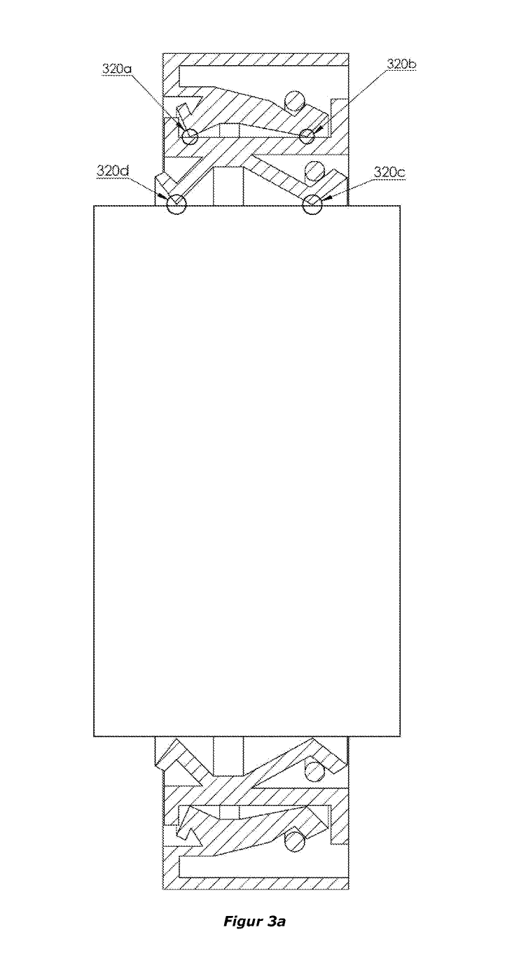

An embodiment of the invention illustrated by FIGS. 3 and 3a is a partial cross section view of a radial seal comprising a first inner seal member 308 and a second outer seal member 301.

The first inner seal member configured to be in sealing contact 320d and 320c with a circular rotating body inside said inner first seal member, such as a shaft or a bearing ring. The first inner seal member is freely rotatable relative to the outer seal and inner body. The first inner seal member comprises seal lips 305 and 307. The spring 306 exerts a radial force on inner body to ensure the lip to be in sealing contact with the counterface on the inner body.

The second outer seal member 301 is arranged to be fixed inside an outer body, such as a housing bore or a bearing ring. An inner circular circumferential of second seal member is in contact with the first inner seal member 308 and has a common seal interface 320a and 320b at the contact surface between the outer and inner seal members.

The second outer seal member comprises seal lips 302 and 304. The outer spring 303 exerts a radial force on inner lip 304 to ensure the lip to be in sealing contact with the counterface on the first inner seal member 308. To reduce the friction coefficient and wear, it is preferred that the common seal interface 320a and 320b comprises one metal surface and one elastomeric/polymeric surface. In an embodiment, the inner seal member has a metallic surface towards the outer seal member and the outer seal member has a elastomeric surface toward the inner seal.

It should be noted that the embodiments illustrated and described were given merely by way of non-limiting indicative examples and that modifications and variations are possible within the scope of the invention as defined by the appended claims. It should be easily understood that the seals can be of combinations of different materials like metal, polymer and elastomer.

Seals exert a certain load on the counterface. The friction resulting from this load is only part of the total contact friction and power loss at the sealing face. Circumferential speed, constant coefficient of friction, temperature, pressure differential across the seal, lubrication, etc are other contributing factors.

The seal described reduces friction, wear and tear by the use of a seal comprising inner and outer circular seal members wherein the seal members are rotatable with respect to each other. The seal further comprises a first intermediate seal member with a common seal interface with said inner seal member and were said first intermediate seal member is rotatable relative said inner and outer seal members. This results in a reduced relative motion at the seal interface. This leads to an extended service life, a reduction in friction and enables a higher maximal speed. The definition parallel connected seals means, that the seal unit has at least two seals that are rotatable relative each other, arranged about an inner body.

### Parallel Connected Seals:

The frictional moment (Equation 1) for 2 parallel connected seals can be expressed by M:

$$\frac{1}{M} = \frac{1}{{M}_{1}} + \frac{1}{{M}_{2}} \qquad ( Equation 1 )$$

As follows from Equation 1, the frictional moment is inversely proportional to the sum of the individual frictional moment components in a device with parallel connected seals. Lowest frictional moment occurs when; M₁=M₂.

For parallel connected seal members to have substantially the same frictional moment they should have a common product of frictional coefficient, a circumferential length and a normal load exerted on the seal surface. This is so that circumferential speeds of the common seal interface (320a, 320b) and sealing contact (320c, 320d) are substantially the same. Friction yields heat and wear and with the use of this invention, the properties for the seals can be adjusted to match the application. The properties such as relative motion between individual seals can be tuned to match the application. If one of the individual rotating seals during use has higher friction than the other, it results in a lower relative speed for that individual seal and higher relative speeds for the other individual rotating seals. The friction loss will be substantially the same for all relatively individual rotating seal (Eq.2).

W_{M1}≈W_{M2} (Equation 2)

What is claimed is:

1. A seal including:
a first inner seal member configured to be in sealing contact with an circular rotating body inside the inner seal member;
and the first inner seal member is configured to rotate relative the circular rotating body;
wherein the seal comprises a second outer seal member configured to be fixed relative an outer body,
wherein an inner circular circumferential of the second seal member has a common seal interface with the first inner seal member, and are individually rotatable.

2. The seal according to claim 1, wherein the first and second seal members comprises respective first and second adjacent seal surface.

3. The seal according to claim 1, wherein the common seal interface and sealing contact have a common product of frictional coefficient, a circumferential length and the normal load exerted by the second seal surface, so that circumferential speeds of the common seal interface and sealing contact are substantially the same.

4. The seal according to any of the preceding claims, wherein at least one of the common seal interfaces comprises a seal lip and an adjacent inner counterface.

5. The seal according to any of the preceding claims, wherein at least one of the common seal interfaces comprises adjacent metal and elastomeric surfaces.

6. The seal according to claim 4, wherein the seal lip has an elastomeric surface and the counterface has a metallic surface.

7. The seal according to claim 1, wherein the inner circular body is an inner bearing ring.

8. The seal according to claim 1, wherein the outer circular body is an outer bearing ring.

9. The seal according to claim 1, wherein the inner circular body is a shaft.

10. The seal according to any of the preceding claims, wherein at least one of the common seal interfaces comprises adjacent metal and polymeric surfaces.

11. The seal according to claim 1, wherein the inner and outer seal members is part of a mechanical seal.

12. The seal according to claim 1-3, wherein the circumferential speed decreases from the inner to the outer rotatable seal member.
